(19) United States
(12) Patent Application Publication
(10) Pub. No.: US 2008/0123535 A1
(43) Pub. Date: May 29, 2008

(54) Maintenance apparatus, IP telephone system, and maintenance data transmission method

(76) Inventors: Shiro Saito, Tokyo (JP); Kazuhiko Seki, Tokyo (JP)

Correspondence Address: INTELLECTUAL PROPERTY / TECHNOLOGY LAW, PO BOX 14329, RESEARCH TRIANGLE PARK, NC, 27709, US

(21) Appl. No.: 11/485,206

(22) Filed: Jul. 12, 2006

(51) Int. Cl. H04L 12/24; H04L 12/56

(52) U.S. Cl. 370/241; 370/389

(57) ABSTRACT

Maintenance apparatus is connected to terminal apparatus equipped with a function for transmitting and receiving audio packets storing audio data via a network. The maintenance apparatus sets a transmission interval for transmitting maintenance packets storing predetermined maintenance data for terminal apparatus to an integer multiple of a transmission interval the terminal apparatus transmits the audio packets by, generates maintenance packets based on the set transmission interval, and sends the generated maintenance packets to the terminal apparatus.

### BACKGROUND

The present invention relates to technology for managing an IP telephone system for carrying out communication services such as calls utilizing VoIP (Voice over Internet Protocol), and particularly relates to maintenance apparatus for carrying out processing relating to maintenance of terminal apparatus.

In recent years, technology for carrying out audio calls using internet protocol (IP) has attracted attention and has started to become widespread. Cases where this kind of call technology is referred to typically as “IP telephony” or “IP telephone system” are common. In IP telephony, an audio signal corresponding to speech generated by a call is converted into digital data, subjected to predetermined compression processing and then put into the form of packets for transmission to a call destination via a network. An analog audio signal is then restored at the call destination using the received packets and outputted as audio. Technology for transmitting and receiving audio data using this kind of internet protocol is referred to as VoIP (Voice over Internet Protocol). Technology of the related art relating to IP telephones is disclosed in documents such as, for example, Japanese Patent Laid-open Publication No. 2001-177577.

### SUMMARY

Here, in the event that an audio packet is transmitted utilizing an IP network, it is easy for phenomena such as “delay” where there is a delay in the time taken by the audio packet to reach its destination, “fluctuation” that is variation in the arrival time of the audio packets, and “packet loss” where audio packets become lost to occur, which is detrimental to call quality and tone quality.

For example, audio packets are transmitted over IP networks and are delivered to the destination via a router but IP packets for various data other than audio packets also flow over these IP networks. As a result, in the event that a router is carrying out transfer processing for other IP packets that are large in size when an IP audio packet arrives at the router, it is necessary for the audio packet to wait until the router has sent out the IP packets that are large in size, which makes it easy for delays and fluctuations to occur.

Further, when IP packets are received, the router temporarily holds the IP packets in a storage area referred to as a “queue” and processes the IP packets on a first-in-first-out basis. IP packets that may overflow from the queue therefore cannot be processed and are discarded. Therefore, when an audio packet arrives in a state where a large number of IP packets have already gathered at the queue, there is the possibility that the audio packet may simply be discarded by the router, which in turns means that packet loss may easily occur.

On the other hand, in maintenance systems of the related art, maintenance packets that are maintenance data put into the form of packets are transmitted over an IP network towards an IP telephone terminal but as a result of a maintenance state, maintenance packets that are extremely large in size are released onto the IP network. As a result, in the event that an audio packet reaches the router when the router is performing transfer processing for a large volume of maintenance data, or in the event that an audio packet arrives when the router is in the middle of queuing a large volume of maintenance packets, the audio packet may be subjected to delays, fluctuations, and/or packet loss because of the maintenance data and this may be detrimental to call quality and/or tone quality. An apparatus capable of transmitting maintenance information without deterioration in call quality of an IP telephone is therefore desirable.

In order to resolve this problem, the present invention sets about the problem of providing maintenance apparatus optimized with respect to an IP telephone system.

The present invention also deals with the problem of constructing a maintenance system capable of transmitting maintenance information for an IP telephone to an IP telephone while ensuring call quality at the IP telephone.

The maintenance apparatus of the present invention is maintenance apparatus connected to terminal apparatus equipped with a function for transmitting and receiving audio packets storing audio data via a network, comprising a setting section setting a transmission interval for transmitting maintenance packets storing predetermined maintenance data for the terminal apparatus based on a transmission interval the terminal apparatus transmits the audio packets by, a generating section for generating maintenance packets based on the transmission interval set by the setting section, and a transmission section transmitting maintenance packets generated by the generating section to the terminal apparatus.

Further, it is also preferable for the setting section to set a transmission interval for transmitting maintenance packets storing predetermined maintenance data for terminal apparatus to an integer multiple of a transmission interval the terminal apparatus transmits the audio packets by.

Further, it is preferable for the setting section to set the transmission interval for transmitting the maintenance packets to ten milliseconds.

Moreover, it is preferable for the setting section to set the transmission interval for transmitting the maintenance packets to integer multiples of ten milliseconds.

Further, the IP telephone system of the present invention is comprised of terminal apparatus having an IP address, and maintenance apparatus connected to the terminal apparatus via a network. The terminal apparatus is comprised of a generating section for generating audio packets storing audio data based on a first transmission interval, and a transmission section transmitting audio packets generated by the generating section. The maintenance apparatus is comprised of a setting section setting a second transmission interval for transmitting maintenance packets storing predetermined maintenance data for the terminal apparatus to a multiple integer of the first transmission interval, a generating section for generating maintenance packets based on the second transmission interval set by the setting section, and a transmission section transmitting maintenance packets generated by the generating section to the terminal apparatus.

Further, a method of transmitting maintenance data of the present invention is a method for transmitting maintenance data in a maintenance apparatus connected to terminal apparatus equipped with a function for transmitting and receiving audio packets storing audio data via a network, comprising the steps of setting a transmission interval for transmitting maintenance packets storing predetermined maintenance data for the terminal apparatus to an integer multiple of a transmission interval the terminal apparatus transmits the audio packets by, generating the maintenance packets in accordance with the set maintenance packet transmission intervals, and transmitting the generated maintenance packets to the terminal apparatus.

The method for transmitting maintenance data of the present invention can be implemented by computer. The computer program for this purpose can be installed or loaded on a computer via various media such as a CD-ROM, magnetic disc, semiconductor memory, or communication network, etc. Further, this may include the case of redistribution by recording the computer program on a predetermined card or board.

According to the present invention, the transmission interval of the maintenance packets is set in accordance with the transmission interval of the audio packets. It is therefore possible to ensure call quality of the IP telephone and send maintenance information for the IP telephone to the IP telephone.

### DESCRIPTION OF THE DRAWINGS

FIG. 1 is an outline view of an IP telephone system to which a first embodiment of the present invention is applied.

FIG. 2 is a function configuration view showing functions of an IP telephone terminal.

FIG. 3 is a function configuration view showing functions of a maintenance server.

FIG. 4A and FIG. 4B are views showing examples of data configurations for IP packets of this embodiment.

FIG. 5 is a flowchart showing a maintenance server processing procedure.

FIG. 6 is a flowchart showing an IP telephone terminal processing procedure.

### DETAILED DESCRIPTION

The present invention sets the transmission interval of maintenance packets in accordance with the transmission interval of audio packets in order to transfer maintenance packets storing maintenance data in such a manner as to not influence the transfer of audio packets storing audio data. Specifically, the transmission interval of the maintenance packets is set to be the same as the transmission interval of the audio packets, or the transmission interval of the maintenance packets is set to be an integer multiple of the transmission interval of the audio packets in order to take into consideration the case of consecutive transmission of audio data in order to reduce overlapping transmission of header information. For example, in the event that audio packets are transferred in accordance with a CELP system audio encoding method defined in ITU-T recommendation J G.729 etc., in this method, 10 milliseconds (10 ms) is set as the encoding unit for audio, and the transmission interval for transmitting maintenance packets is set to be an integer multiple of 10 milliseconds.

The following is a description with reference to the drawings of embodiments of the present invention. The maintenance terminal apparatus of the present invention is applied to an IP telephone system for making calls utilizing VoIP (Voice over IP).

[System Outline View]

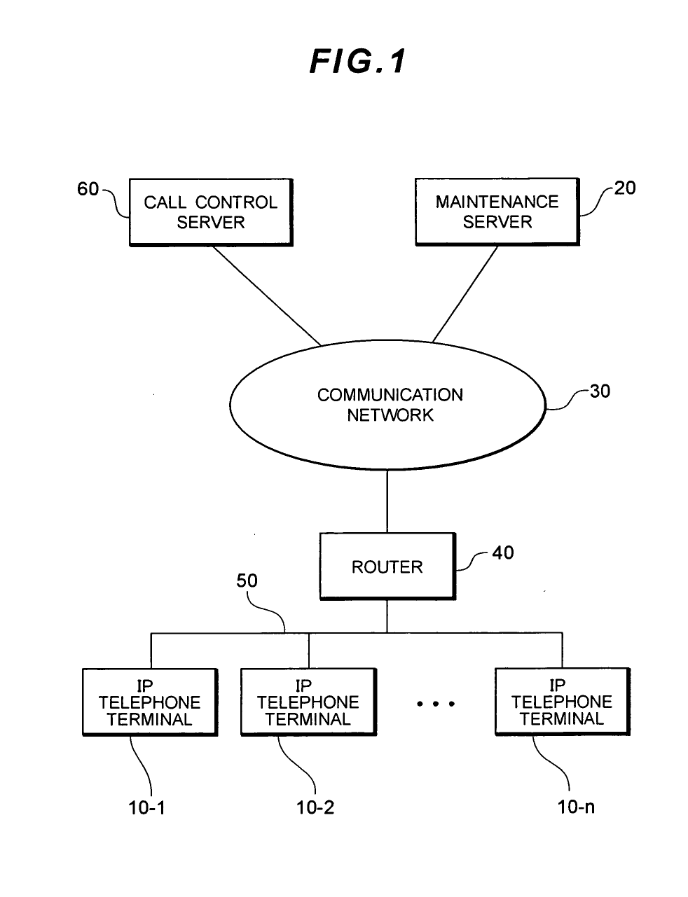

FIG. 1 is an outline view of an IP telephone system to which a first embodiment of the present invention is applied. As shown in the same drawing, this IP telephone system is comprised of one or more IP telephone terminals 10-1, 10-2 . . . 10-n, a router 40 connected with the IP telephone terminals 10 via a LAN (Local Area Network), a maintenance server 20 connected to the IP telephone terminals 10 via the router 40 and a predetermined communication network (for example, the Internet) 30, and a call control server 60 similarly connected to the IP telephone terminals 10 via router 40 and the predetermined communication network 30, for managing calls of the IP telephone terminals 10. In this IP telephone system, audio packets storing audio data, maintenance packets storing maintenance data, and packets storing other data are transferred via the communication network 30.

Each IP telephone terminal 10 is equipped with a respective IP address, and is mainly equipped with an audio encoding function for converting analog audio signals to digital signals, a packet function for processing audio signals put into digital form as IP packets, an address conversion function for converting telephone numbers inputted from an input section (not shown) into IP addresses for packet destination IP addresses, and a call control function for managing calls according to a predetermined call control protocol.

Existing technology such as PCM (Pulse Code Modulation) methods and CS-ACELP (Conjugate-structure algebraic code excited linear prediction) methods etc. can be utilized as methods for encoding audio according to the specification. For example, in the case of a high-speed line, a high tone quality PCM method may be adopted, and in the case of a low-speed line, a CS-ACELP method etc. capable of regulating bandwidth may be adopted.

For example, H.323 protocol utilized on TCP (Transmission Control Protocol) and SIP (Session Initiation Protocol) utilized on UDP (User Datagram Protocol) etc. exist as call control protocols. In this embodiment, a description is given of the case of using SIP as an example. In this case, the IP terminals 10 function as SIP clients.

Further, each IP telephone terminal 10 has a maintenance function for receiving maintenance information sent from maintenance server 20 and executing processing in accordance with the maintenance information. The maintenance information can be transferred in accordance with a predetermined communication protocol. An arbitrary protocol can be taken as the communication protocol for use in the transmission and receipt of maintenance information but here a description is given of the case of employing a call control protocol.

The IP telephone terminal 10 of this embodiment is configured as a single apparatus equipped with the above functions but the configuration of the IP telephone terminal 10 is by no means limited in this respect. For example, that constructed by connecting an analog telephone apparatus and VoIP gateway corresponds to the IP telephone terminal 10 of this embodiment. Further, this may also be general purpose information processing apparatus such as a headset for telephone use (microphone and speaker) or a program for implementing the aforementioned functions.

The router 40 is path selection apparatus (repeater) equipped with a function for reading an IP address for a destination written into an IP packet and transmitting the IP packet in an optimum direction. Further, router 40 may also be equipped with a firewall function for preventing penetration by third parties via an external network.

The maintenance server 20 is equipped with a function for, for example, updating and changing data and programs within the IP telephone terminal 10 as necessary, and a fault recovery function for remotely monitoring the operating state of the IP telephone terminal 10 externally and giving notification of fault content and carrying out a recovery operation through remote operation at the item of a fault, as normal functions ensuring a superior operating state for the IP telephone system.

A feature of the maintenance server 20 of this embodiment is that during transmission of the maintenance information to the IP telephone terminal, transmission takes place in such a manner as to not influence the call quality of the IP telephone terminal, or more specifically, maintenance packets are transmitted taking into consideration transmission intervals of the audio packets. The maintenance server 20 adopts a predetermined call control protocol (SIP) as a predetermined communication protocol for transmitting the maintenance information.

The call control server 60 manages calls of each IP telephone terminal 10 so as to perform call control. Specifically, call control is implemented by storing and collectively managing information such as a predetermined table correlating telephone numbers and IP addresses, and call history etc., and transmitting and receiving information with each IP telephone terminal 10 in accordance with a predetermined call control protocol. Here, as SIP is used as a call control protocol, call control apparatus 60 functions as an SIP server.

LAN 50 of this embodiment is a network assembled from an Ethernet (registered trademark) etc., and functions as a transmission path for call control signals and call signals. This also functions as a transmission path for data signals in the event that other apparatus (not shown) such as personal computers etc. are connected. Further, the communication network 30 taken to be the Internet is a plurality of networks mutually connected together, and transmits packet data defined, for example, using the TCP/IP protocol.

[Outline of Call operation Occurring at IP Telephone System]

Next, a description is given of an outline of the operation from the start of a call to the end of a call occurring at an IP telephone system configured in this manner. First, when a call instruction containing a telephone number is received from an operator via an input/output section (not shown), an IP telephone terminal 10-1 assigns a connection request packet containing this telephone number and a connection request message to an IP address of a call control server 60 and transmits this to a LAN 50. Here, it is taken that a telephone number of IP telephone terminal 10-n is assigned. When this connection request packet is received, the router 40 sends this to the communication network 30 in accordance with the IP address.

When a connection request packet addressed to itself is received from communication network 30, call control server 60 refers to a predetermined table to acquire an IP address corresponding to the telephone number contained in this connection request packet, and transfers to this acquired IP address (i.e. IP address of IP telephone terminal 10-n). The IP telephone terminal 10-n then receives a connection request packet, and in the event that it is itself in a state where calling is possible, sends back a connection possible packet to the effect that connection is possible to the call control server 60. Upon receiving the connection possible packet, the call control server 60 transfers to the IP telephone terminal 10-a sending the connection request.

The IP telephone terminal 10-1 receiving the connection possible packet then sends a confirmation packet for receipt of the connection possible packet to call control server 60, and the call control server 60 transfers this confirmation packet to the IP telephone terminal 10-n. As a result, a communication path (call) is established between the IP telephone terminal 10-1 and the IP telephone terminal 10-n, and a state where an audio call is possible is proceeded to. After this, it is possible to implement a call by sending and receiving audio packets storing audio signals between call side IP telephone terminal 10-1 and receiving side IP telephone terminal 10-n in accordance with RTP (Real-time Transport Protocol). It is then necessary for each audio packet to reliably arrive at each IP telephone terminal within a fixed time in order to maintain call quality.

[Configuration View of IP Telephone Terminal]

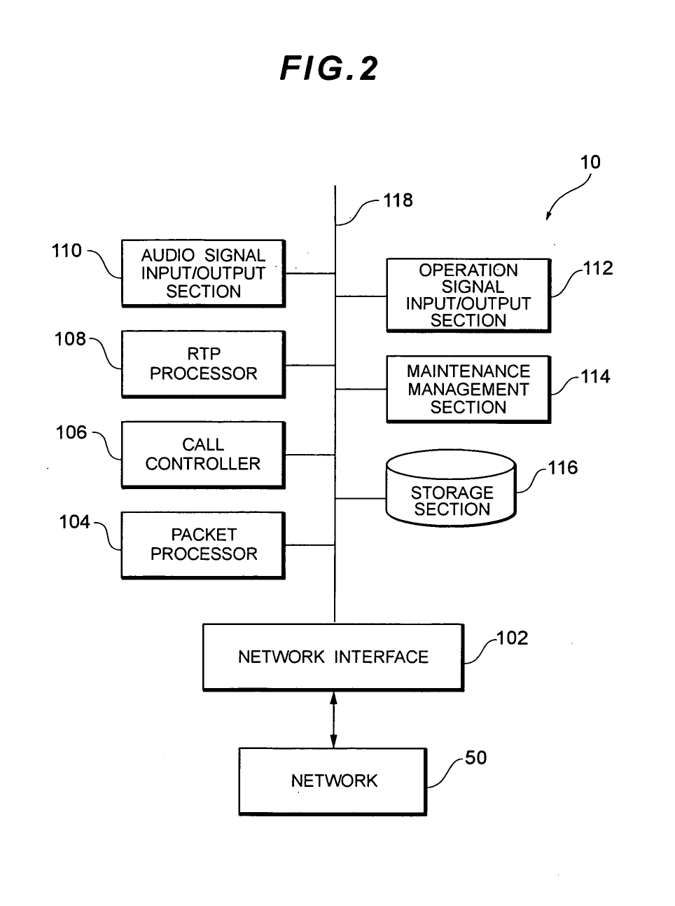

FIG. 2 is a function configuration view showing functions of an IP telephone terminal. IP telephone terminal 10 is equipped with network interface section 102, packet processor 104, call controller 106, RTP processor 108, audio signal input/output section 110, operation signal input/output section 112, maintenance management section 114, storage section 116, and bus 118.

The network interface section 102 is an interface for physically connecting the IP telephone terminals 10 and the network (LAN) 50. The network interface section 102 physically/logically converts internal data of IP telephone terminal 10 for transmission to the network 50, extracts data addressed to itself flowing on the network 50, and physically/logically converts this data for input to the bus 118.

The packet processor 104 processes packets transmitted to and received from the network 50 via the network interface section 102. The packet processor 104 removes IP headers from packets received, for example, via network interface section 102 and reads out TCP/UDP headers. Applications intended to process these packets are then determined in accordance with the port number within the TCP/UDP header. For example, in the event that the port number indicates the presence of control data relating to call control, this control data is delivered to the call controller 106, and in the event that the presence of audio data is indicated, this data is delivered to the RTP processor 108. Further, data generated at the call controller 106, RTP processor 108, and the maintenance management section 114 is added to the header and transmitted via the network interface section 102.

The call controller 106 executes call processing in accordance with predetermined call control protocol. Further, in the event that maintenance information is stored in the data in accordance with the call control protocol, this maintenance information is transmitted to the maintenance management section 114. The call controller 106 of this embodiment executes call processing in accordance with SIP as described above. The call controller 106 interprets data of a text format described in accordance with predetermined session description language (for example, SDP: session description protocol) and carries out communication of requests/responses with the call control server 60.

The RTP processor 108 relays call signals between the audio signal input/output section 110 and the packet processor 104 in accordance with RTP that is a protocol for streaming playback of audio and images that is a host protocol of UDP. The RTP processor 108 adds header information in accordance with RTP to a digital audio signal that is the analog audio signal inputted by the audio signal input/output section 110 converted by an audio encoder (not shown) so as to generate audio packets, and passes these audio packets over to the packet processor 104. Further, in the event that an audio packet is received, the RTP processor 108 rearranges the audio packets based on header information in accordance with RTP, and passes the audio packets over to an audio decoding section (not shown).

The audio signal input/output section 110 corresponds to a handset for inputting the voice of the caller and outputting the voice of the opponent. An analog audio signal inputted by audio signal input/output section 110 is converted to a digital audio signal in accordance with a predetermined method by an audio encoder (not shown). Further, the audio composing section (not shown) converts the received digital audio signal to an analog audio signal, for output from audio signal input/output section 110 as an analog signal. Operation signal input/output section 112 corresponds to a dial button etc. for input operations of input of telephone numbers by a user and input of various instructions.

The maintenance management section 114 executes processing in accordance with maintenance information received in accordance with a predetermined communication protocol. The maintenance management section 114 of this embodiment executes call processing in accordance with SIP as described above. For example, in the event that received maintenance information is a setting request for predetermined information (for example, a numbering plan table described later), predetermined information set at itself is updated. Further, in the event that the received maintenance information is an acquisition request for information (for example, status indicating talk conditions) set at itself, the instructed information is acquired and sent back.

Storage section 116 stores each of the various information necessary for a call by the IP telephone 10. For example, an own telephone number and IP address are stored in a corresponding manner, and a table (hereinafter referred to as “numbering plan table”) correlating a call destination and predetermined numerals allocated to the call destination is stored. This numbering plan table is specifically for correlating call destinations and upper order digits of telephone numbers allocated to the call destinations. A configuration is adopted where, when the telephone number of the call destination is inputted by the user, the call destination can be specified by referring to the upper order digits of the numbering plan table in accordance with the inputted numbers.

Further, the storage section 116 stores a call control module defining connection processing for connecting with a connection destination network for each connection destination network the IP telephone 10 connects to. This call control module is exemplified by the existence of an individual module each connection destination network, i.e. each carrier operating a connection destination network. The number design table and the call control module are updated by the maintenance management section 114.

This kind of IP telephone terminal 10 is equipped with a CPU (not shown), ROM storing programs executed by the CPU, and RAM for temporarily storing each type of information. For example, the call controller 106 is implemented as a result of the CPU executing various controls based on predetermined control programs stored in ROM or external storage apparatus, etc.

[Configuration View of Maintenance Server]

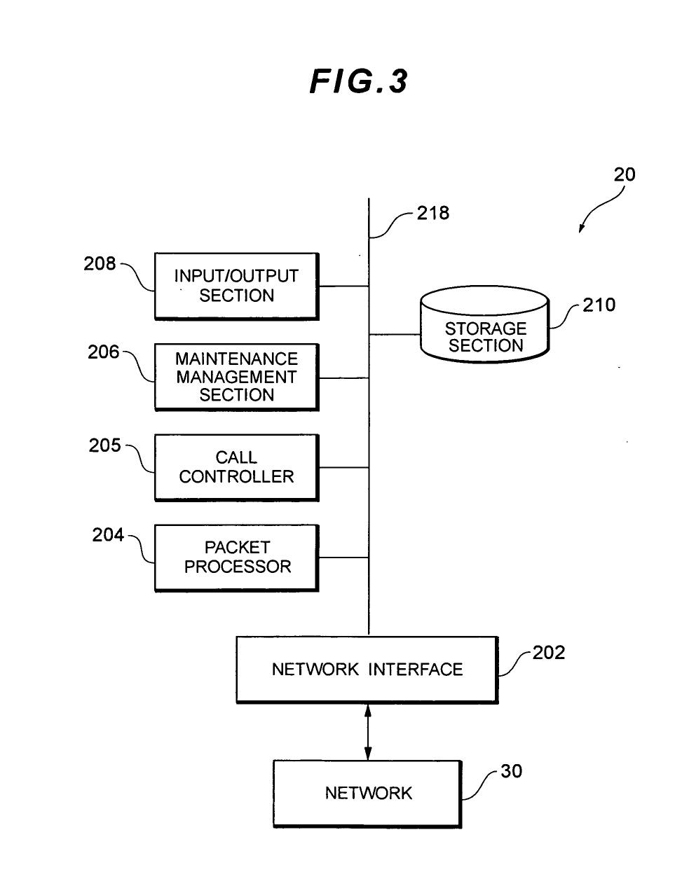

FIG. 3 is a function configuration view showing functions of a maintenance server. The maintenance server 20 is equipped with a network interface 202, packet processor 204, maintenance management section 206, input/output section 208, storage section 210, and bus 218.

The network interface 202 is an interface for physically connecting with a network (the Internet). The network interface 202 physically/logically converts internal data of the maintenance server 20 for transmission to the network 30, extracts data addressed to itself flowing on the network 30, and physically/logically converts this data for input to the bus 218.

The call controller 205 executes call processing in accordance with predetermined call control protocol. The call controller 205 of this embodiment executes call processing in accordance with SIP. The call controller 205 establishes a communication path with the IP telephone terminal 10 by interpreting data of a text format described in accordance with predetermined session description language and carrying out communication of requests/responses with the call control server 60.

The packet processor 204 processes packets transmitted to and received from the network 30 via the network interface 202. The packet processor 204 extracts data constituting a target from packets received via the network interface 202 and passes this data over to the maintenance management section 206. Further, a destination is assigned to the data generated at the maintenance management section 206 and transmitted via the network interface 202.

The maintenance management section 206 executes maintenance processing for the IP telephone terminal 10. The maintenance processing may be registration and update processing of maintenance information to the storage section 116 or may be processing for observing the IP telephone terminal 10. The maintenance management section 206 reads out predetermined information (numbering plan table etc.) stored in the storage section 210 in accordance with instructions inputted by the input/output section 208 and pre-set conditions and generates a setting request containing the read-out information and setting instructions. Further, maintenance management section 206 generates an acquisition request containing information to be acquired (a status indicating a call state of the IP telephone terminal etc.) and acquired instructions in accordance with the instructions inputted by the input/output section 208 and preset conditions. The maintenance information composed of generated setting requests and acquisition requests is converted to data in accordance with a predetermined communication protocol and maintenance packets are generated.

Further, the maintenance management section 206 of this embodiment sets transmission intervals for transmitting maintenance packets generated in such a manner as to not influence the call quality of the IP telephone terminal 10. Specifically, maintenance management section 206 sets the transmission interface for the maintenance packets in such a manner as to give a transmission interval that is an integer multiple of the transmission interval the IP telephone terminal 10 transmits the audio packets at.

The input/output section 208 corresponds to an input section of a keyboard and mouse etc. for the user to input predetermined instructions and an output section of a display and speaker etc.

The storage section 210 stores maintenance information for the IP telephone terminal 10. This maintenance information conceptually includes all kinds of information for making the IP telephone terminal 10 operate in an appropriate manner. For example, this maintenance information may correspond to a control program for causing the IP telephone terminal 10 to operate, setting information set at the IP telephone terminal 10, and state information indicating the state of the IP telephone terminal, etc. Further, the storage section 210 is equipped with a management table (not shown) for managing the maintenance conditions of each IP telephone terminal. The correlation of IP telephone terminals 10 that are the targets of this maintenance and this maintenance information is stored in this management table.

This kind of maintenance server 20 is equipped with a CPU (not shown), ROM storing programs executed by the CPU, and RAM for temporarily storing each type of information. The CPU operates as, for example, the maintenance management section 206 by executing various controls based on predetermined control programs stored in ROM or external storage apparatus, etc.

[Data Format]

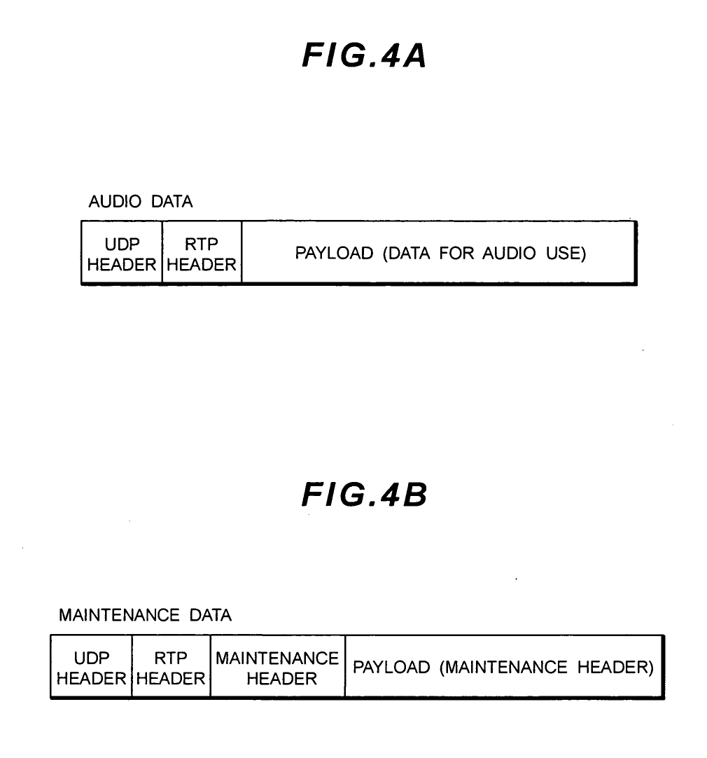

Next, a description is given of the configuration of data of this embodiment using FIG. 4A and FIG. 4B. FIG. 4A is a view showing an example of a data configuration of an audio packet storing audio information. The audio packet is configured from an RTP packet wrapped in a UDP packet. Each packet is equipped with header information for each UDP and RTP communication, and audio information is stored in the payload. FIG. 4B is a view showing an example of a data configuration for a maintenance packet storing maintenance information. The maintenance packet is also configured from an RTP packet wrapped in a UDP packet. Each packet is configured from a UDP header, RTP header, and maintenance header, with a header for maintenance use and data for maintenance use (setting request and acquisition request for certain information) being stored in the payload (audio communication data region). Maintenance information is described, for example, in not-yet-defined portions (not-yet-defined fields) of the call control protocol.

[Flow of Transmission Processing for the Maintenance Information]

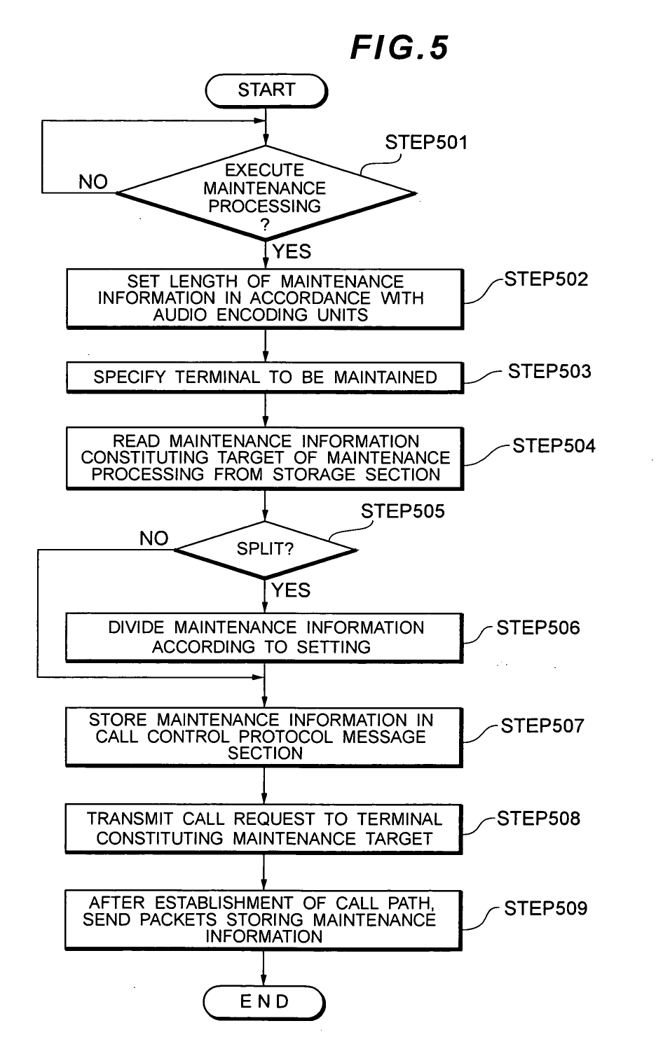

FIG. 5 is a flowchart showing a maintenance server processing procedure. Specifically, an outline of the program processing contents of the call controller 205, maintenance management section 206, and packet processor 204 of the maintenance server 20 is shown.

First, maintenance management section 206 determines whether or not to execute maintenance processing (step 501). For example, in the event that execution of maintenance processing designating a specific time for a specific IP telephone terminal is inputted via input/output section 208, the maintenance management section 206 determines execution of maintenance processing. Further, in the event that an access time for the IP telephone terminal 10 and an IP telephone terminal 10 that is a target are set in advance, execution of maintenance processing in accordance with these settings is determined.

The maintenance management section 206 determining execution of the maintenance processing then generates maintenance packets in such a manner that the transmission interval of maintenance packets storing maintenance information becomes an integer multiple of the transmission interval of the audio packets of the IP telephone terminal 10. In the event that the IP telephone terminal 10 conforms to CELP system audio encoding methods defined in ITU-T recommendation G.729, the audio encoding units described above are 10 milliseconds, with code encoded at 10 bytes using an 8 kbps encoding system and encoded for 80 bytes at an encoding method of 64 kbps being generated. In the event that a 64 kbps encoding method is adopted, the data length of the maintenance packets is set to be the same value (80 bytes) as the data length of the audio packets, and as the maintenance packets are configured from a maintenance header region and a data region, a region for a 70 bytes portion is set as the region for storing maintenance information.

Next, the maintenance management section 206 specifies the IP telephone terminal 10 constituting a target of maintenance in accordance with the inputted information or set conditions (step 503). Further, in the event that maintenance processing is the setting of predetermined information, the maintenance management section 206 reads out information that is the target of setting from the storage section 210 in accordance with the inputted information or set conditions (step 504).

In the event that the information to be loaded on the maintenance packet is in excess of the region set for storing maintenance information (a maintenance information length of, for example, 70 bytes) (step 505), the maintenance management section 206 divides maintenance information to be transmitted according to the data length that can be allocated to the region (step 506).

Next, the maintenance management section 206 stores maintenance information (in the case of splitting up, divided maintenance information) in accordance with a data format of a call control procedure protocol the IP telephone terminal 10 that is the target is compatible with (step 507). Here, maintenance information is information relating to processing that is different to processing for call control originally predicted by the call control procedure protocol. The maintenance management section 206 therefore holds the maintenance information in predetermined portions (not-yet-defined fields) that are not utilized in call control, for the data format of the call control procedure protocol. As a result, at the IP telephone terminal 10, it is possible to interpret and execute maintenance information without the occurrence of call control processing errors or malfunction occurring.

There are also cases where the call control procedure protocol adopted by each IP telephone terminal 10 is different for each IP telephone terminal. It is therefore taken that information for call control procedure protocols the IP telephone terminal 10 is compatible with is stored in advance in the storage section 210 and inputted via the input/output section 208.

The call controller 205 sends a connection request packet containing connection information (telephone number) for the IP telephone terminal 10 and a connection request message to the communication network 30 via the packet processor 204 (step 508). After this, when a call path is established with the IP telephone terminal 10 via the call control server 60, a packet storing maintenance information at a not-yet defined portion of the call control procedure protocol is transmitted (step 509). In the event of a normal call, when a call path is established, IP packets storing audio signals in accordance with RTP are transmitted and received between the call side maintenance server 20 and the receiving side IP telephone terminal 10 but, here, rather than audio packets, packets storing maintenance information are sent from the maintenance server 20 to the IP telephone terminal 10.

[IP Telephone Terminal Processing Procedure]

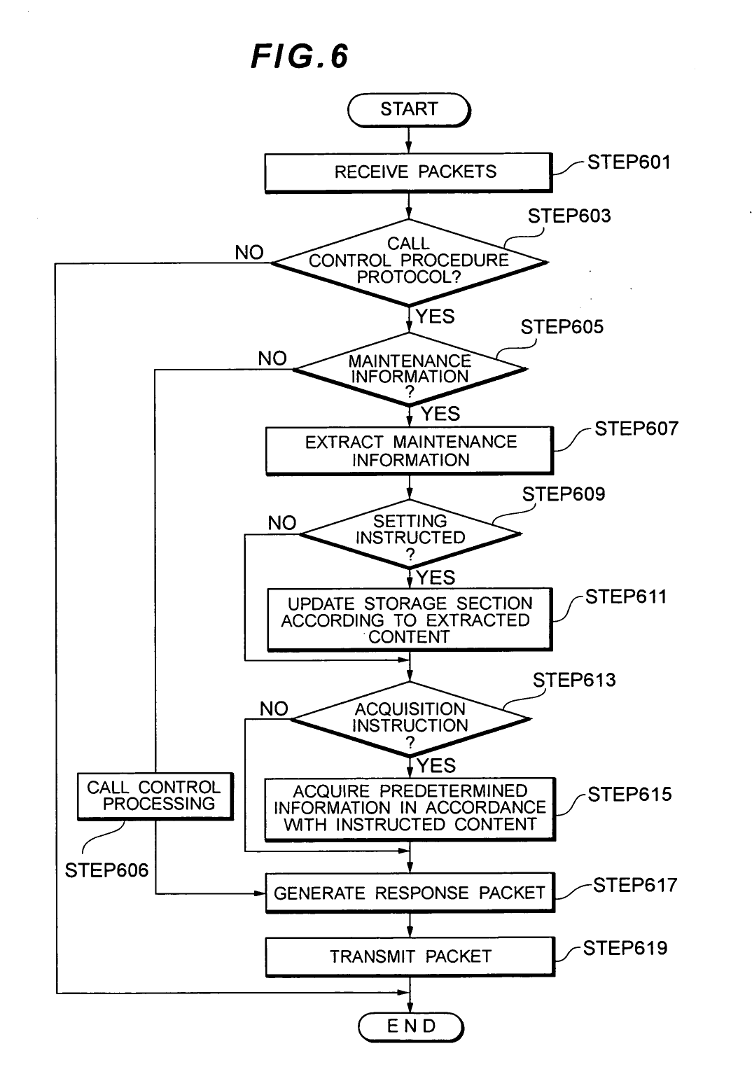

FIG. 6 is a flowchart showing a processing procedure for an IP telephone terminal 10. Specifically, and outline of processing content of a program for packet processor 104, call controller 106, and maintenance management section 206 of IP telephone terminal 10 is shown.

When a packet is received via the network interface 50 (step 601), the packet processor 104 determines whether or not data contained in the received packet is data conforming to a predetermined call control protocol (step 603). In the event that it is determined that the data contained in the received packet is data conforming to a predetermined call control protocol (step 603; Yes), this data is passed over to the call controller 106.

The call controller 106 then determines whether or not the passed over data is for transmitting maintenance data (step 605). Specifically, in the event that maintenance information is stored in not-yet-defined portions within a data format of a call control protocol, it is determined that this is data for transmitting maintenance information (step 605; Yes), and the maintenance information is extracted (step 607). On the other hand, in the event that information relating to call control is stored in accordance with a data format of a call control protocol, the data is not data for transmitting maintenance information (step 605; No), and call control processing is executed (step 606).

The maintenance management section 114 then executes maintenance processing based on maintenance information extracted by the call controller 106. For example, in the event that the maintenance information is setting instructions for information (step 609; Yes), the maintenance management section 114 updates the storage section 116 in accordance with the extracted information (step 611).

On the other hand, in the event that the maintenance information is information acquisition instructions (step 613; Yes), predetermined information is acquired in accordance with the instructed content (step 615). At the maintenance management section 114 also, the transmission interval for maintenance packets containing acquired predetermined information is also set to an integer multiple (an integer multiple of ten milliseconds in the case that the transmission interval for audio packets is ten milliseconds) of the transmission interval for the audio packets. Namely, the maintenance management section 114 sets the packet length of the maintenance packets to the same length as the packet length of the audio packets, and divides the returned information according to the corresponding set packet length. The packet processor 104 is then notified of the execution results for the maintenance processing.

The packet processor 104 then generates a response packet taking the maintenance server 20 as a destination in accordance with the notified content (step 617), and the network interface section 102 transmits this (step 619).

According to this embodiment, the transmission interval of the maintenance packets storing maintenance information sent to the IP telephone terminal 10 is set to an integer multiple of the transmission interval of the audio packets storing the audio information. It is therefore possible for the causes of delays and fluctuations in audio packets due to the flow of maintenance packets of the network to be avoided.

Further, according to this embodiment, it is possible to ensure call quality of IP telephones and it is possible to send maintenance information for IP telephones to IP telephones. It is therefore possible to provide maintenance apparatus optimized for an IP telephone system.

Moreover, according to this embodiment, predetermined maintenance information is transmitted in accordance with a call control protocol the IP telephone terminal is compatible with. It is therefore possible to execute maintenance control on IP telephone terminals from maintenance servers arranged on an external network.

Still further, it is possible to transmit predetermined maintenance information without being dependent on a firewall function of a router 40 the IP telephone terminal 10 is connected to, and it is therefore possible to provide more flexible maintenance servers.

Moreover, maintenance information is stored in not-yet-defined portions within the call control messages. It is therefore possible to avoid subjecting call control processing occurring on the IP telephone terminal side receiving this maintenance information from being subjected to the influence of errors, etc.

In the above embodiment, each process is described sequentially but a configuration where the processing order is switched around or performed in parallel is also possible providing that this is not inconsistent with the operation. Further, the present invention is by no means limited to the content of the embodiments described above, and various modified examples are possible while remaining within the essential scope of the present invention.

(1) In the above embodiment, a configuration is adopted where the transmission intervals for the maintenance data are set taking into consideration the transmission intervals of the audio packets occurring at the IP telephone terminal 10 but a configuration performing setting taking into consideration causes other than the transmission interval for the audio packets may also be adopted. For example, it may be considered to adjust the transmission interval of maintenance data taking into consideration the degree of congestion of communication paths. For example, when the degree of congestion of a communication path is low, a ten millisecond interval is adopted, with the transmission interval then being made broader in accompaniment with an increase in congestion so as to reduce overlapping transmission of header information.

(2) In the above embodiment, the transmission interval for the maintenance information is set to ten milliseconds but the value of the transmission interval is by no means limited in this respect. For example, a configuration may be adopted where a plurality of values are prepared as values for transmission intervals, with these values then being appropriately selected according to the audio packet transmission method.

(3) Further, in the above embodiment, a description is given of the case where SIP is used as the communication protocol for transmitting maintenance information but the present invention is by no means limited in this respect, and other communication protocols may also be used according to the specification. Further, the maintenance target is by no means limited to an IP telephone, and a target such as a gateway or SIP server etc. may also be adopted.

(4) In the above embodiment, a description is given taking an example of a case including a setting instruction and acquisition instruction but the maintenance information may also be configured only from either one of these instructions (for example, setting support).

1. A maintenance apparatus for connection to terminal apparatus adapted to transmit and receive audio packets storing audio data via a network, said maintenance apparatus comprising:
a setting section setting a transmission interval for transmitting maintenance packets storing predetermined maintenance data for the terminal apparatus based on a transmission interval for transmission of the audio packets by the terminal apparatus;
a generating section for generating the maintenance packets based on transmission intervals set by the setting section; and
a transmission section transmitting the maintenance packets generated by the generating section to the terminal apparatus.

2. The maintenance apparatus according to claim 1, wherein the setting section sets a transmission interval for transmitting the maintenance packets to an integer multiple of a transmission interval for transmission of the audio packets by the terminal apparatus.

3. The maintenance apparatus according to claim 1, wherein the setting section sets the transmission interval for transmitting the maintenance packets to ten milliseconds.

4. The maintenance apparatus according to claim 1, wherein the setting section sets the transmission interval for transmitting the maintenance packets to an integer multiple of ten milliseconds.

5. An IP telephone system including terminal apparatus having an IP address, and maintenance apparatus connected to the terminal apparatus via a network, the terminal apparatus comprising:
a generating section for generating audio packets storing audio data based on a first transmission interval; and
a transmission section transmitting audio packets generated by the generating section, and
the maintenance apparatus comprising:
a setting section setting a second transmission interval, for transmitting maintenance packets storing predetermined maintenance data for the terminal apparatus, to a multiple integer of the first transmission interval;
a generating section for generating the maintenance packets in accordance with the second transmission interval set by the setting section; and
a transmission section transmitting the maintenance packets generated by the generating section to the terminal apparatus.

6. A method for transmitting maintenance data in a maintenance apparatus connected to terminal apparatus adapted to transmit and receive audio packets storing audio data via a network, the method comprising the steps of:
setting a transmission interval, for transmitting maintenance packets storing predetermined maintenance data for the terminal apparatus, to an integer multiple of a transmission interval for transmission of the audio packets by the terminal apparatus;
generating the maintenance packets in accordance with the set maintenance packet transmission intervals; and
transmitting the generated maintenance packets to the terminal apparatus.
